(19) United States
(12) Patent Application Publication
(10) Pub. No.: US 2026/0056371 A1
(43) Pub. Date: Feb. 26, 2026

(54) OPTICAL CONNECTION COMPONENT AND OPTICAL CONNECTION METHOD

(71) Applicants: SUMITOMO ELECTRIC INDUSTRIES, LTD., Osaka-shi, Osaka (JP); Sumitomo Electric Optifrontier Co., Ltd., Yokohama-shi, Kanagawa (JP); Nippon Tsushin Denzai Co., Ltd., Komaki-shi, Aichi (JP)

(72) Inventors: Yasuyuki MAEKAWA, Yokohama-shi (JP); Shunichi WATANABE, Osaka-shi (JP); Masaki OMURA, Osaka-shi (JP); Daichi YAMADA, Komaki-shi (JP); Takayuki YOKOCHI, Osaka-shi (JP); Motoyoshi KIMURA, Komaki-shi (JP)

(73) Assignees: SUMITOMO ELECTRIC INDUSTRIES, LTD., Osaka-shi, Osaka (JP); Sumitomo Electric Optifrontier Co., Ltd., Yokohama-shi, Kanagawa (JP); Nippon Tsushin Denzai Co., Ltd., Komaki-shi, Aichi (JP)

(21) Appl. No.: 19/105,464

(22) PCT Filed: Sep. 7, 2022
(86) PCT No.: PCT/JP2022/033616

§ 371 Date: Feb. 21, 2025

(51) Int. Cl. G02B 6/38; G02B 6/40

(52) U.S. Cl. CPC G02B 6/3871; G02B 6/3825; G02B 6/3831; G02B 6/406

(57) ABSTRACT

An optical connection component according to one embodiment comprises: an optical connector that has a ferrule which holds an optical fiber; a rotation member that has an insertion hole into which the optical connector is inserted along the optical axis direction of the optical fiber; and an adapter that the optical connector inserted into the insertion hole connects to. The adapter has a latch with which the optical connector that moves along the optical axis direction engages. The rotation member has a movement mechanism that moves the optical connector along the optical axis direction by rotating with respect to the adapter about a center axis which extends along the optical axis direction.

### TECHNICAL FIELD

The present disclosure relates to an optical connection component and an optical connection method.

### BACKGROUND ART

Patent literature 1 describes an optical connection component that optically connects a pair of fiber optic connectors via an adapter. The fiber optic connector includes an inner connector body that houses a first ferrule and a second ferrule, and a rear connector body connected to the inner connector body. Each of the first ferrule and second ferrule holds an optical fiber. The rear connector body has a handle extending in the direction opposite to the inner connector body. The inner connector body has a latch arm extending in the optical axis direction of the optical fiber. The adapter has a groove with which the latch arm engages.
Patent literature 2 describes an optical connector. The optical connector includes an optical receptacle and an optical plug to be inserted into the optical receptacle. The optical plug has an engaging section that engages with the optical receptacle. The engaging section includes an engagement piece that hooks the optical receptacle and a protruding portion which enters into a hole formed in the optical receptacle.
Patent literature 3 describes an adapter assembly. The adapter assembly includes an adapter, a plug inserted into the adapter, and a ferrule holder functioning as a fiber optic connector inserted into the plug. The ferrule holder houses a plurality of ferrules for holding optical fibers. The ferrule holder has a latch extending obliquely upward from the top surface. The ferrule holder is attached to the plug by the latch engaging with the plug.
Patent literature 4 describes an optical connector and a connection method of an optical connector. The optical connector includes an optical receptacle and an optical plug coupled to the optical receptacle. The optical receptacle has an outer housing, an inner housing, and a receptacle-side ferrule housed in the inner housing. The optical plug has a plug-side housing and a plug-side ferrule housed in the plug-side housing. The inner housing has an engaging portion, and the plug-side housing has an engaged portion and a lock releasing portion.
Patent literature 5 describes a connection structure of an optical connector. This connection structure has a plug receptacle having a port and a plug connector to be inserted into the port. The connection structure further includes a release member that enables removal of the plug connector from the port.

### CITATION LIST

### Patent Literature

Patent literature 1: U.S. Patent Application Publication No. 2017/0227720
Patent literature 2: U.S. Patent Application Publication No. 2020/0257064
Patent literature 3: U.S. Patent Application Publication No. 2021/0255403
Patent literature 4: Japanese Unexamined Patent Application Publication No. 2018-36589
Patent literature 5: WO 2022/036119

### SUMMARY OF INVENTION

An optical connection component according to the present disclosure includes an optical connector including a ferrule holding an optical fiber, a rotating member having an insertion hole into which the optical connector is inserted in an optical axis direction of the optical fiber, and an adapter to which the optical connector inserted into the insertion hole is connected. The adapter has a latch with which the optical connector transferring in the optical axis direction engages. The rotating member has a transfer mechanism configured to transfer the optical connector in the optical axis direction by rotating with respect to the adapter about a central axis extending in the optical axis direction.

An optical connection method according to the present disclosure is an optical connection method of optically connecting an optical connector including an optical fiber to a mating connector via an adapter, and the method includes: preparing a rotating member having an insertion hole into which the optical connector is inserted in an optical axis direction of the optical fiber; inserting the optical connector into the insertion hole; and by rotating the rotating member with respect to the adapter about a central axis extending in the optical axis direction, transferring the optical connector in the optical axis direction and engaging the optical connector with a latch of the adapter.

### BRIEF DESCRIPTION OF THE DRAWINGS

FIG. 1 is a cross-sectional view of an optical connection component according to an embodiment.

FIG. 2 is a perspective view of the optical connection component of FIG. 1.

FIG. 3 is an exploded perspective view of an optical connector of the optical connection component of FIG. 1.

FIG. 4 is a front view of the optical connector of FIG. 3.

FIG. 5 is a perspective view showing a front housing of the optical connector of FIG. 4.

FIG. 6 is a perspective view showing a middle housing of the optical connector of FIG. 4.

FIG. 7 is a perspective view showing a rear housing of the optical connector of FIG. 4.

FIG. 8 is a side surface view showing an adapter of the optical connection component of FIG. 1.

FIG. 9 is a cross-sectional view of the adapter of FIG. 8.

FIG. 10 is a side surface view showing a rotating member of the optical connection component of FIG. 1.

FIG. 11 is a perspective view showing the rotating member of FIG. 10.

FIG. 12 is a cross-sectional perspective view of the rotating member of FIG. 10.

FIG. 13 is a perspective view showing the rear housing of FIG. 7.

FIG. 14 is a diagram showing one step of an optical connection method according to an embodiment.

FIG. 15 is a diagram showing one step of an optical connection method according to an embodiment.

FIG. 16 is a diagram showing one step of an optical connection method according to an embodiment.

FIG. 17 is a diagram showing one step of an optical connection method according to an embodiment.

FIG. 18 is a diagram showing one step of an optical connection method according to an embodiment.

FIG. 19 is a diagram showing one step of an optical connection method according to an embodiment.

### DETAILED DESCRIPTION

In the optical connection component and the optical connection method, a plurality of optical fibers held by each of a plurality of ferrules may have to be connected by physical contact (PC). However, when the number of optical fibers or the number of ferrules of the optical connector is large, the increase in the fitting load of the optical connector may make it difficult to perform PC connection of all the optical fibers. When ultra multi-core optical fibers are PC-connected, it may be difficult to manually insert the optical connector and connect the optical connectors.

An object of the present disclosure is to provide an optical connection component and an optical connection method that can easily connect optical connectors.

### Description of Embodiments of Present Disclosure

First, embodiments of the present disclosure will be listed and described.
(1) An optical connection component according to an embodiment includes an optical connector including a ferrule holding an optical fiber, a rotating member having an insertion hole into which the optical connector is inserted in an optical axis direction of the optical fiber, and an adapter to which the optical connector inserted into the insertion hole is connected. The adapter has a latch with which the optical connector transferring in the optical axis direction engages. The rotating member has a transfer mechanism configured to transfer the optical connector in the optical axis direction by rotating with respect to the adapter about a central axis extending in the optical axis direction.

In this optical connection component, the optical connector has the ferrule holding the optical fiber, and the optical connector is connected to the adapter. The adapter has the transfer mechanism configured to transfer the optical connector in the optical axis direction. Since the adapter, instead of the optical connector, has the transfer mechanism, the optical connector can be miniaturized and the optical connector can be easily inserted into the adapter. The optical connection component includes the rotating member that rotates about the central axis extending in the optical axis direction, and the rotating member is provided with the insertion hole into which the optical connector is inserted. The rotating member transfers the optical connector in the optical axis direction by rotating. Thus, the optical connector can be transferred in the optical axis direction by the rotation of the rotating member, and the optical connector can be engaged with the latch. Thus, the optical connector can be easily connected.
(2) In the above (1), the rotating member may have a latch pressing member configured to press the latch with the optical connector engaged. In this case, the latch pressing member presses the latch with the optical connector engaged, and thus the opening of the latch can be more reliably suppressed. Thus, the optical connector can be firmly engaged with the adapter.
(3) In the above (1) or (2), the transfer mechanism may have an inclined surface that comes into contact with the optical connector inserted into the insertion hole. The rotating member may push the optical connector that comes into contact with the inclined surface toward the adapter by rotating. In this case, since the transfer mechanism has the inclined surface, the configuration of the transfer mechanism for transferring the optical connector can be simplified. The optical connector can be pushed toward the adapter by the rotating member rotating in a state in which the optical connector is in contact with the inclined surface. Thus, the rotating member is rotated, and the optical connector can be pushed toward the adapter, and thus the optical connector can be easily connected to the adapter.
(4) In any one of the above (1) to (3), the optical connector may include a plurality of the ferrules and a housing unit housing the plurality of ferrules. In this case, the housing unit houses the plurality of ferrules, and thus the plurality of ferrules of the optical connector can be collectively optically connected.
(5) In the above (4), in the housing unit, the plurality of ferrules may be arranged in a first direction intersecting the optical axis direction, and may be arranged in a second direction intersecting both the optical axis direction and the first direction. In this case, the plurality of ferrules arranged in the first direction and the second direction can be collectively optically connected.
(6) In the above (4) or (5), the housing unit may include a front housing having a recessed portion with which the latch engages. In this case, the latch of the adapter can be engaged with the recessed portion formed in the front housing of the optical connector.
(7) In the above (6), the front housing may have a rectangular parallelepiped shape. In this case, the front housing can be formed in a simple shape, which contributes to further miniaturization of the optical connector.
(8) In the above (6) or (7), the ferrule may be housed in the front housing.
(9) In any one of the above (4) to (8), the housing unit may include a middle housing including a space forming portion forming a space through which the optical fiber held by the ferrule passes. In this case, the optical fiber extending from the ferrule can be passed through the space of the middle housing.
(10) In the above (9), the optical connector may include a spring member interposed between the ferrule and the middle housing. In this case, the ferrule can be biased by the spring member.
(11) In the above (9) or (10), the housing unit may include a rear housing with which the transfer mechanism comes into contact, and the middle housing may be housed in the rear housing. In this case, the transfer mechanism can be brought into contact with the rear housing that houses the middle housing.
(12) In the above (11), the rear housing may have a tubular portion into which the optical fiber is inserted, and a protruding portion protruding from the tubular portion in a first direction intersecting the optical axis direction. The protruding portion may enter the insertion hole, and the transfer mechanism may transfer the optical connector by coming into contact with the protruding portion having entered the insertion hole. In this case, the transfer mechanism can transfer the optical connector toward the adapter by coming into contact with the protruding portion that protrudes from the tubular portion in the first direction.
(13) In the above (11) or (12), the rear housing may have a non-circular shape in a cross section orthogonal to the optical axis direction. In this case, the rear housing can be more easily inserted into the insertion hole.
(14) In any one of the above (11) to (13), the rear housing and the insertion hole may have flat shapes extending in a first direction intersecting the optical axis direction in a cross section orthogonal to the optical axis direction. In this case, the rear housing can be more easily inserted into the insertion hole.
(15) In any one of the above (1) to (14), the rotating member may have a plurality of the transfer mechanisms disposed at positions with the insertion hole interposed. In this case, when the plurality of transfer mechanisms transfer the optical connector, the optical connector can be more easily connected to the adapter.
(16) In the above (2), the transfer mechanism and the latch pressing member may be disposed so as to be arranged in the optical axis direction.
(17) In the above (2) or (16), the rotating member may have a plurality of the latch pressing members disposed at positions with the insertion hole interposed. In this case, since the opening of the latch can be suppressed by the plurality of latch pressing members, the optical connector can be engaged with the adapter more firmly.
(18) In any one of the above (1) to (17), the rotating member may have an adapter housing portion having a tubular shape and configured to house the adapter. In this case, the rotating member can be rotated with respect to the adapter in a state in which the adapter is housed.
(19) In the above (18), the adapter housing portion may have a slit extending in a rotation direction of the rotating member. The adapter may have a projecting portion that is inserted into the slit. In this case, the rotating member is able to rotate smoothly in the rotation direction by rotating the rotating member with respect to the adapter in a state in which the projecting portion is inserted into the slit.
(20) In the above (19), the slit may have an extending portion extending in the rotation direction, and a depression recessed in the optical axis direction at an end portion in the rotation direction of the extending portion. The projecting portion may enter the depression when the optical connector engages with the latch. The rotating member may transfer in the optical axis direction so that the transfer mechanism separates from the optical connector when the projecting portion enters the depression. In this case, when the optical connector engages with the latch, the transfer mechanism of the rotating member can be transferred away from the optical connector.
(21) In the above (1) to (20), a rotation angle of the rotating member with respect to the adapter may be 30 degrees to 170 degrees. In this case, the movement amount of the optical connector which transfers as a result of rotation of the rotating member can be sufficiently secured.
(22) An optical connection method according to the present disclosure is an optical connection method of optically connecting an optical connector including an optical fiber to a mating connector via an adapter, and the method includes: preparing a rotating member having an insertion hole into which the optical connector is inserted in an optical axis direction of the optical fiber; inserting the optical connector into the insertion hole; and, by rotating the rotating member with respect to the adapter about a central axis extending in the optical axis direction, transferring the optical connector in the optical axis direction and engaging the optical connector with a latch of the adapter.

In this optical connection method, the optical connector is connected to the adapter, and the adapter has the transfer mechanism transferring the optical connector in the optical axis direction. Since the adapter, instead of the optical connector, has the transfer mechanism, the optical connector can be miniaturized and the optical connector can be easily inserted into the adapter. In the optical connection method, the rotating member which is provided with the insertion hole into which the optical connector is inserted and which rotates about the central axis extending in the optical axis direction is used. The rotating member transfers the optical connector in the optical axis direction by rotating. Thus, the optical connector can be transferred in the optical axis direction by the rotation of the rotating member, and thus the optical connector can be engaged with the latch. Thus, the optical connector can be easily connected.

### Details of Embodiments of Present Disclosure

Specific examples of an optical connection component and an optical connection method according to an embodiment will be described below with reference to the drawings. The present invention is not limited to the following examples, but is intended to include all modifications within the scope of the claims and equivalents thereof. In the description of the drawings, the same or corresponding elements are denoted by the same reference numerals, and redundant description thereof will be appropriately omitted. In the drawings, some components may be simplified or exaggerated for easy understanding, and the dimensional ratios and the like are not limited to those shown in the drawings.

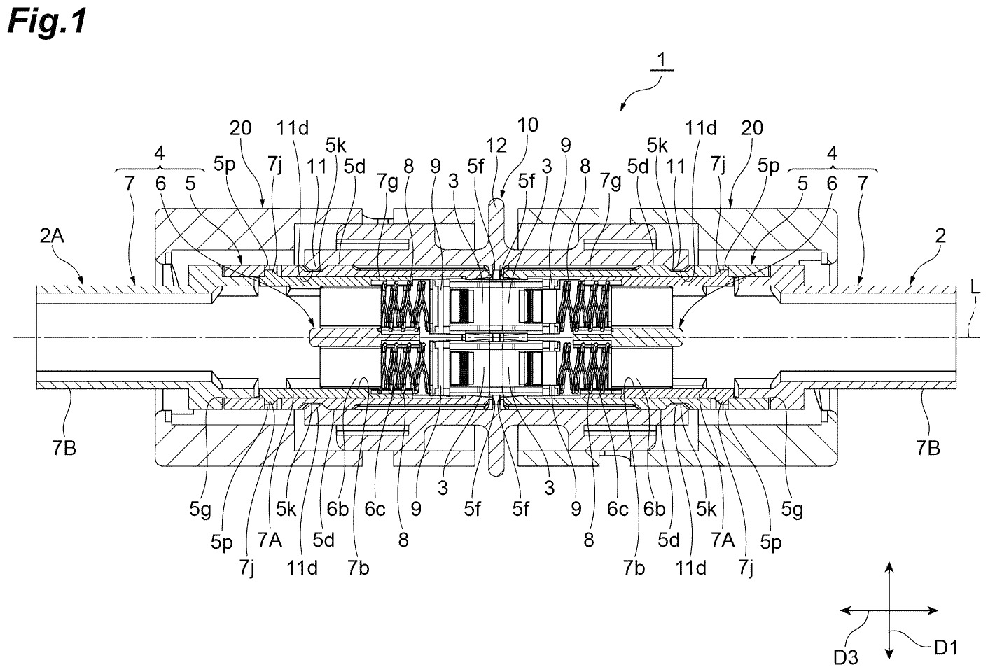

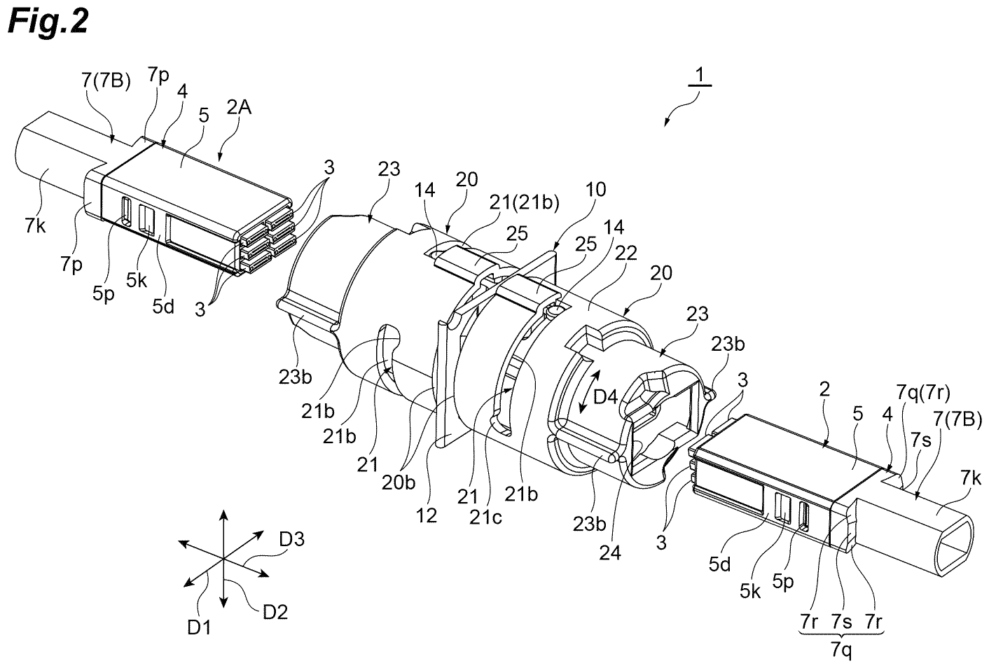

FIG. 1 is a cross-sectional view showing an optical connection component 1 as an example. FIG. 2 is a perspective view showing optical connection component 1. As shown in FIG. 1 and FIG. 2, optical connection component 1 includes an adapter 10 to which an optical connector 2 is connected, and a rotating member 20 attached to adapter 10 so as to be rotatable. Optical connector 2 and a mating connector 2A are connected to adapter 10. A material of components constituting each of optical connection component 1 and optical connector 2 may be, for example, a resin material such as polycarbonate (PC), polyetherimide (PEI), polyamide (PA), polyacetal (POM), polyphenylene ether (PPE), polybutylene terephthalate (PBT), polyphenylene sulfide (PPS), or polyethersulfone (PES), or a composite material in which glass fibers or glass spheres are filled in a resin material.

Optical connector 2 is connected to adapter 10 to be connected to mating connector 2A. The configuration of mating connector 2A may be different from the configuration of optical connector 2. However, in the following, an example in which the configuration of mating connector 2A is the same as the configuration of optical connector 2 will be described, and the description of the configuration of mating connector 2A will be appropriately omitted.

Optical connection component 1 includes, for example, one adapter 10 and two rotating members 20. Rotating members 20 are attached to adapter 10 so as to be rotatable about a central axis L extending in a direction D3 intersecting both a first direction D1 and a second direction D2, which is a width direction of adapter 10. Adapter 10 has a latch 11 with which optical connector 2 transferring in direction D3 engages. Rotating member 20 connects optical connector 2 to adapter 10 by rotating about central axis L. Second direction D2 is a direction orthogonal to first direction D1 as an example.

In optical connection component 1, two rotating members 20 are arranged in direction D3. Direction D3 is, for example, a direction orthogonal to both first direction D1 and second direction D2. Optical connector 2 has, for example, a rectangular parallelepiped shape. Optical connector 2 is connected to adapter 10 so as to be arranged to adapter 10 in direction D3. Direction D3 corresponds to a connection direction of optical connector 2 to adapter 10. Rotating member 20 is provided to come into contact with optical connector 2 in rotating member 20 and push optical connector 2 into the center of adapter 10 in direction D3. Hereinafter, a direction in which optical connector 2 is pushed may be referred to as front, front side, or forward, and a direction opposite to the direction in which optical connector 2 is pushed in may be referred to as rear, rear side, or rearward.

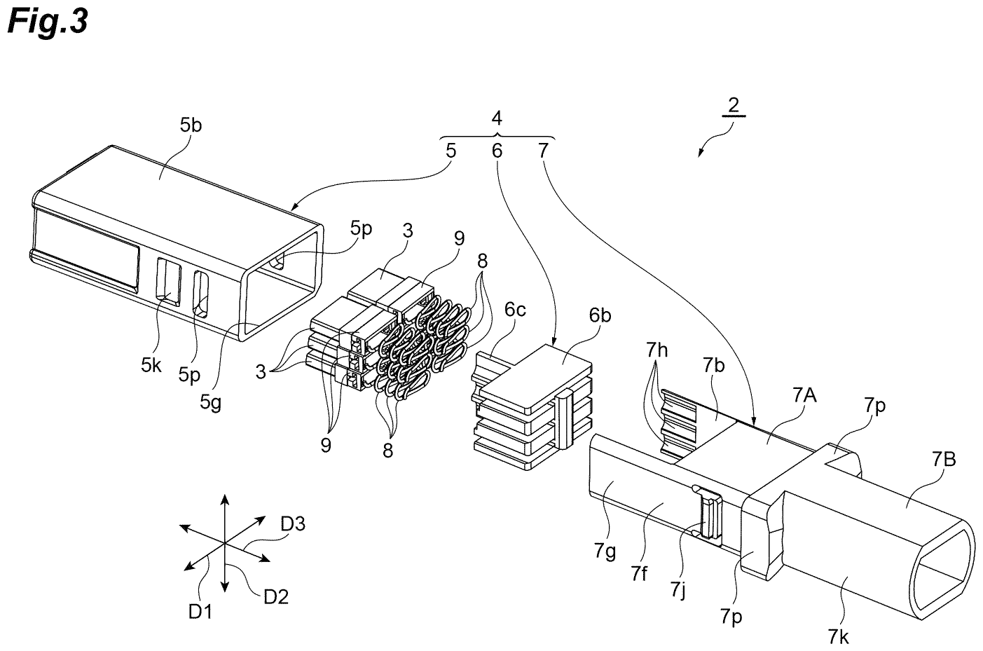

FIG. 3 is an exploded perspective view of optical connector 2. As shown in FIG. 1, FIG. 2, and FIG. 3, optical connector 2 has, for example, a ferrule 3 and a housing unit 4 housing ferrule 3. Housing unit 4 includes, for example, a front housing 5, a middle housing 6, and a rear housing 7. Optical connector 2 includes a spring member 8 for biasing ferrule 3, and a pin keeper 9 for holding a guiding pin inserted into ferrule 3.

Optical connector 2 has, for example, a plurality of ferrules 3 that are housed in housing unit 4. In housing unit 4, the plurality of ferrules 3 are arranged in first direction D1 and are arranged in second direction D2. Two ferrules 3 are arranged in first direction D1, and three ferrules 3 are arranged in second direction D2 as an example.

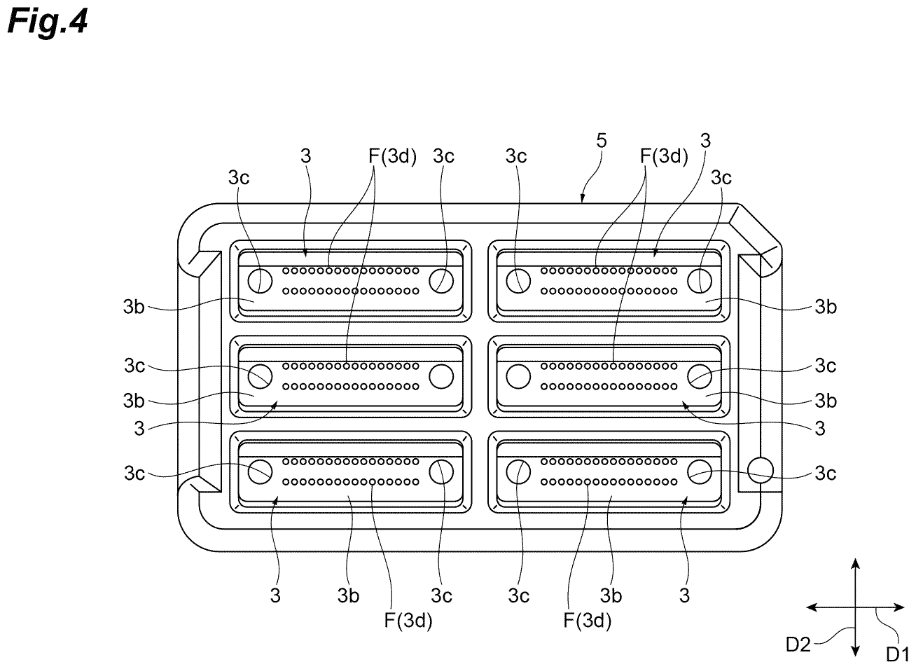

FIG. 4 is a front view of optical connector 2 when optical connector 2 is viewed in direction D3. As shown in FIG. 2 and FIG. 4, each ferrule 3 has an end surface 3b facing mating connector 2A and is provided with guiding holes 3c through which the guiding pins described above are inserted. Guiding hole 3c passes through ferrule 3 in direction D3. Two guiding holes 3c are arranged in first direction D1. Optical connector 2 has an optical fiber F held by ferrule 3. Optical fiber F extends from end surface 3b of ferrule 3 in direction D3. Direction D3 is an optical axis direction of optical fiber F. For simplifying the drawings, optical fiber F is not shown in the drawings other than FIG. 4.

Ferrule 3 is provided with a plurality of optical fiber holding holes 3d holding optical fibers F, and each optical fiber holding hole 3d passes through ferrule 3 in direction D3. The plurality of optical fiber holding holes 3d are formed between the pair of guiding holes 3c on end surface 3b. On end surface 3b, the plurality of optical fiber holding holes 3d are arranged in first direction D1 and are arranged in second direction D2. As an example, ferrule 3 is provided with 32 optical fiber holding holes 3d. In this case, the number of cores of optical connector 2 (the number of optical fibers F) is 192. For example, on end surface 3b, two optical fiber holding holes 3d are arranged in second direction D2, and sixteen optical fiber holding holes 3d are arranged in first direction D1.

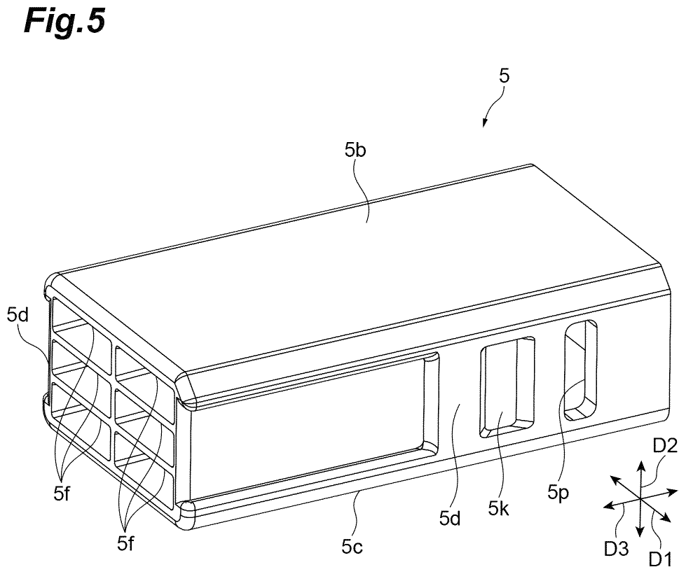

FIG. 5 is a perspective view showing front housing 5. As shown in FIG. 1, FIG. 2 and FIG. 5, front housing 5 has a rectangular parallelepiped shape. For example, a length of front housing 5 in direction D3 is longer than a length of front housing 5 in first direction D1, and the length of front housing 5 in first direction D1 is longer than a length of front housing 5 in second direction D2. Front housing 5 has, for example, an upper surface portion 5b, a lower surface portion 5c, and a pair of side surface portions 5d. Upper surface portion 5b extends in both first direction D1 and direction D3, and lower surface portion 5c faces opposite to upper surface portion 5b. The pair of side surface portions 5d faces first direction D1 and is arranged in first direction D1.

Ferrule 3 is housed in front housing 5. Front housing 5 has a first opening 5f from which ferrule 3 is exposed and a second opening 5g into which middle housing 6 and rear housing 7 are inserted. First opening 5f faces forward, and second opening 5g faces rearward. Ferrule 3 protrudes from first opening 5f. For example, front housing 5 has the same number of first openings 5f as the number of ferrules 3, and each ferrule 3 protrudes from each first opening 5f.

Front housing 5 has a recessed portion 5k to be engaged with latch 11 of adapter 10 described later. Recessed portion 5k is formed in each of the pair of side surface portions 5d arranged in first direction D1. For example, recessed portion 5k has a rectangular shape when viewed in first direction D1. For example, the cross-sectional shape of recessed portion 5k when cut along a plane extending in both first direction D1 and direction D3 has a trapezoidal shape. Latch 11 of adapter 10 is engaged with recessed portion 5k, and thus optical connector 2 is connected to adapter 10.

Front housing 5 is provided with an engagement hole 5p to be engaged with rear housing 7. Front housing 5 is provided with engagement hole 5p in each of the pair of side surface portions 5d. Engagement hole 5p has, for example, an oval shape extending in second direction D2. Rear housing 7 is engaged with engagement hole 5p from the inner side of front housing 5. Thus, rear housing 7 is mounted on front housing 5.

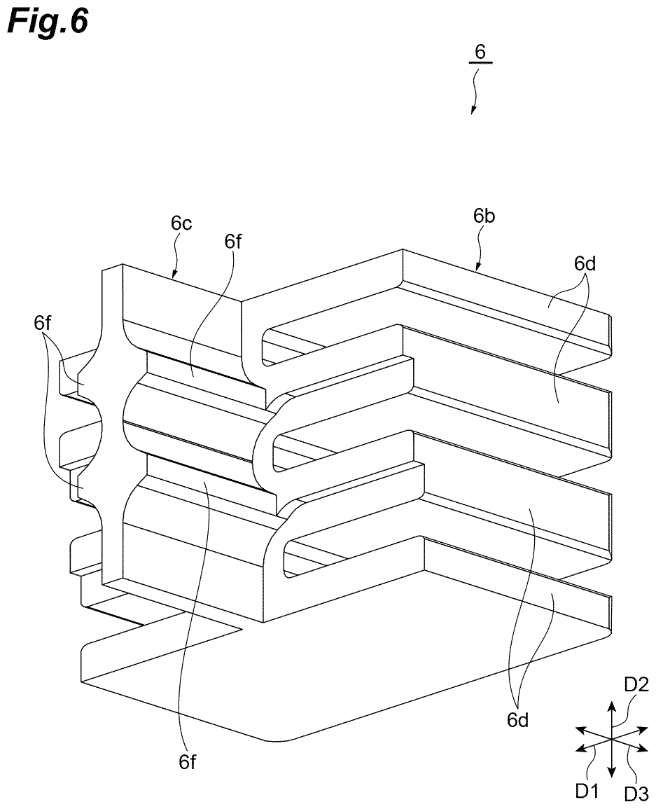

FIG. 6 is a perspective view showing middle housing 6. As shown in FIG. 1 and FIG. 6, middle housing 6 includes a space forming portion 6b forming a space through which optical fiber F held by ferrule 3 passes. For example, middle housing 6 includes space forming portion 6b and a spring disposition portion 6c located forward of space forming portion 6b. Space forming portion 6b has a plurality of plate-like portions 6d extending in both first direction D1 and direction D3, and arranged in second direction D2. Optical fiber F is passed through the space formed between the pair of plate-like portions 6d arranged in second direction D2 so as to extend in direction D3. For example, when middle housing 6 enters into rear housing 7, the end surface of plate-like portion 6d facing first direction D1 gets contacted with an inner side surface 7b of rear housing 7.

Spring disposition portion 6c is a portion in which spring members 8 are disposed. Spring disposition portion 6c protrudes forward from, for example, the center of space forming portion 6b in first direction D1. Spring disposition portion 6c has a plate shape extending in both second direction D2 and direction D3. Spring disposition portion 6c has a plurality of protruding portions 6f protruding in first direction D1 and arranged in second direction D2. Spring member 8 is disposed on each end portion side of spring disposition portion 6c in second direction D2 when viewed from protruding portion 6f, and between the pair of protruding portions 6f. Spring member 8 is interposed between ferrule 3 and middle housing 6. More specifically, one end of spring member 8 comes into contact with pin keeper 9, and the other end of spring member 8 comes into contact with the front end surface of plate-like portion 6d. Spring member 8 biases toward the front side of pin keeper 9 and ferrule 3 with respect to middle housing 6.

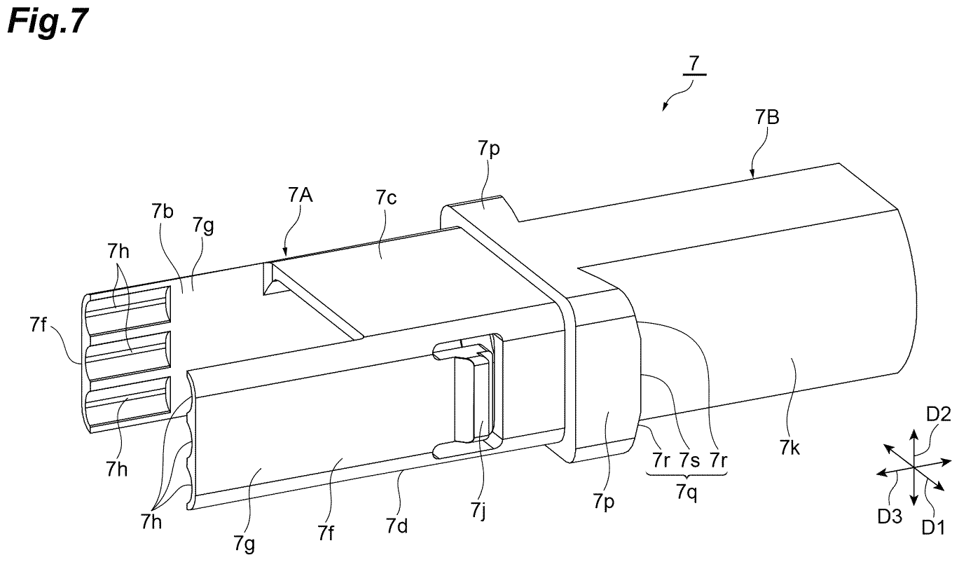

FIG. 7 is a perspective view showing rear housing 7. As shown in FIG. 1 and FIG. 7, a part of rear housing 7 is housed in front housing 5. For example, a length of rear housing 7 in direction D3 is longer than a length of rear housing 7 in first direction D1, and the length of rear housing 7 in first direction D1 is longer than a length of rear housing 7 in second direction D2.

Rear housing 7 has, for example, an inserted portion 7A that is to be inserted into front housing 5 and an exposed portion 7B located rearward of inserted portion 7A. Inserted portion 7A has, for example, an upper surface portion 7c, a lower surface portion 7d, and a pair of side surface portions 7f. Upper surface portion 7c extends in both first direction D1 and direction D3, and lower surface portion 7d faces opposite to upper surface portion 7c. The pair of side surface portions 7f faces first direction D1 and is arranged in first direction D1.

Side surface portion 7f has a protruding portion 7g that protrudes forward with respect to each of upper surface portion 7c and lower surface portion 7d. Side surface portions 7f have a pair of protruding portions 7g arranged in first direction D1. Middle housing 6 is housed between the pair of protruding portions 7g. Spring housing portions 7h are provided on inner side surface 7b of rear housing 7. Spring housing portion 7h has a concave shape. Spring member 8 is housed in a space formed between spring housing portion 7h and spring disposition portion 6c of middle housing 6.

Rear housing 7 has a projecting portion 7j to engage with front housing 5. Projecting portion 7j is formed in each of the pair of side surface portions 7f arranged in first direction D1. Projecting portion 7j is a portion to be fitted into engagement hole 5p of front housing 5 from the inner side of front housing 5. For example, the shape of projecting portion 7j when cut along a plane extending in both first direction D1 and direction D3 is a trapezoidal shape. Rear housing 7 is mounted on front housing 5 by engaging projecting portion 7j with engagement hole 5p.

As shown in FIG. 2 and FIG. 7, rear housing 7 has a non-circular shape in a cross section orthogonal to direction D3. As an example, in a cross section orthogonal to direction D3, rear housing 7 has a flat shape extending in first direction D1. Exposed portion 7B of rear housing 7 has a tubular portion 7k through which optical fiber F passes and a protruding portion 7p protruding from an end portion of tubular portion 7k in first direction D1. For example, the cross-sectional shape of tubular portion 7k when tubular portion 7k is cut by a plane orthogonal to direction D3 is a shape in which the short sides of the rectangle are curved so as to swell outward. Protruding portion 7p is located, for example, at the front end of tubular portion 7k. Rear housing 7 has a pair of protruding portions 7p, and the pair of protruding portions 7p protrude from tubular portion 7k toward both end sides in first direction D1.

Protruding portion 7p is a portion with which rotating member 20 to be described later comes into contact. Protruding portion 7p has a contact surface 7q that comes into contact with rotating member 20. Contact surface 7q is a surface facing rearward of protruding portion 7p. Contact surface 7q includes inclined surfaces 7r respectively located at both ends in second direction D2 and a top surface 7s located in a region including the center in second direction D2. Protruding portion 7p has a pair of inclined surfaces 7r, and top surface 7s is formed between the pair of inclined surfaces 7r. Inclined surface 7r is inclined with respect to second direction D2. Inclined surface 7r is inclined so as to protrude rearward as it approaches top surface 7s. Top surface 7s extends, for example, in both first direction D1 and second direction D2.

Next, adapter 10 will be described. As shown in FIG. 1 and FIG. 2, adapter 10 has a plate-like portion 12 extending in both first direction D1 and second direction D2, as an example. For example, plate-like portion 12 and a portion other than a projecting portion 14 described later in adapter 10 are housed in rotating member 20. Adapter 10 has latch 11 with which optical connector 2 engages inside rotating member 20. Adapter 10 has a circular tubular shape, as an example. Plate-like portion 12 spreads outward, for example, in a radial direction of adapter 10 at the center of adapter 10 in direction D3. Plate-like portion 12 do not have to spread outward in the radial direction of adapter 10 over the entire circumference direction (rotation direction D4) of rotating member 20. Plate-like portion 12 may spread outward in the radial direction of adapter 10 only at a part of rotating member 20 in the circumferential direction (rotation direction D4). Furthermore, plate-like portion 12 may be omitted.

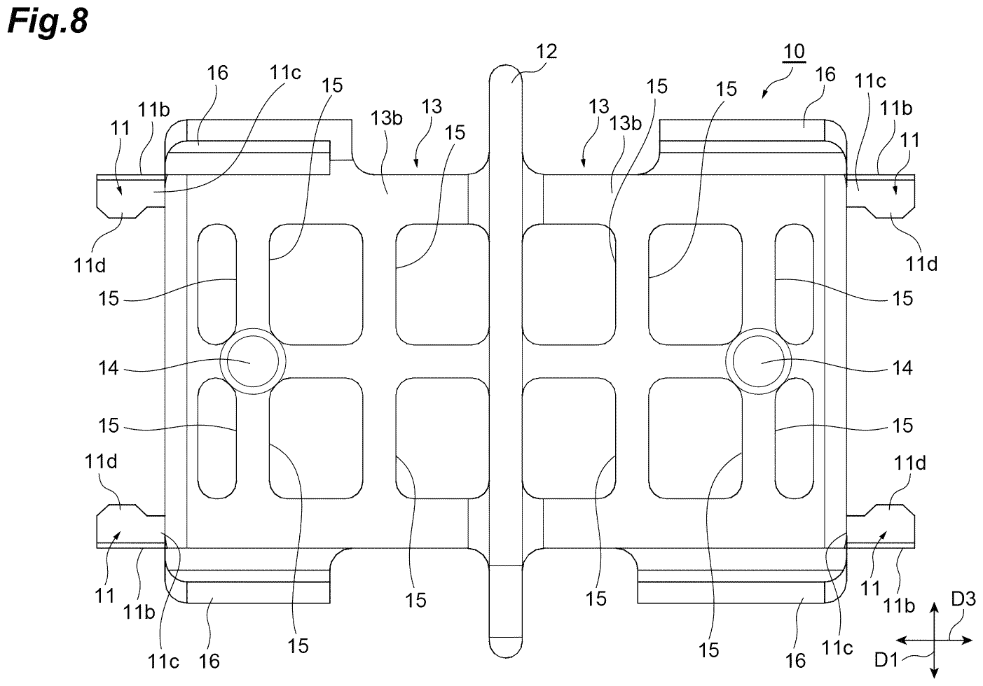

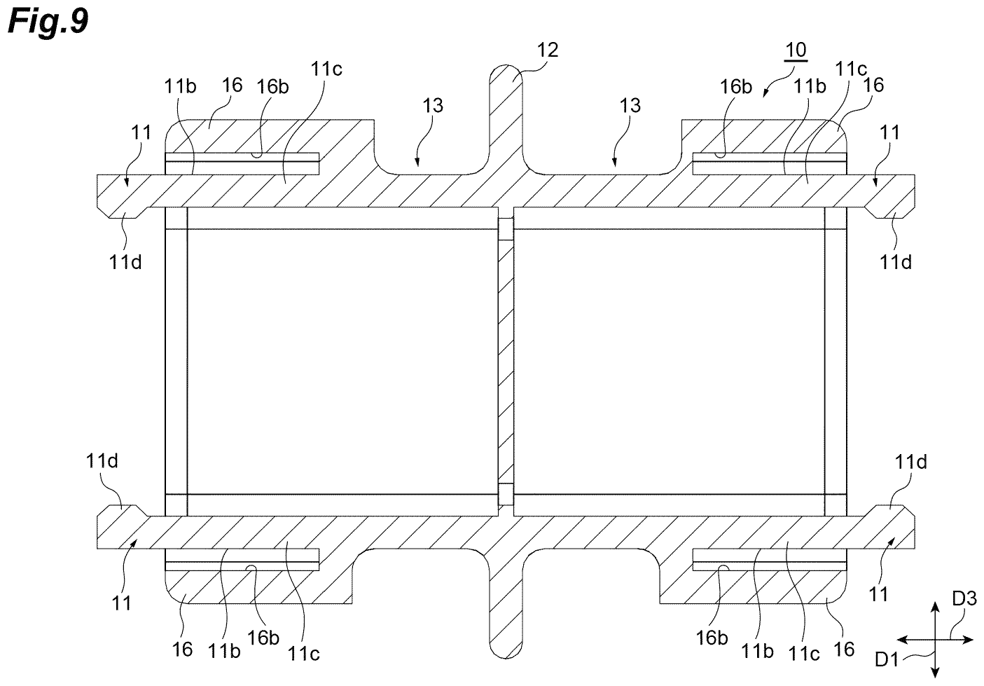

FIG. 8 is a side surface view showing adapter 10. FIG. 9 is a cross-sectional view of adapter 10 cut by a plane extending in both first direction D1 and direction D3. As shown in FIG. 8 and FIG. 9, adapter 10 has, for example, an inserted-to-rotating member portion 13 that is inserted into rotating member 20. Inserted-to-rotating member portion 13 has a circular tubular shape, as an example. Adapter 10 has a pair of inserted-to-rotating member portions 13, and inserted-to-rotating member portions 13 are provided on each of both sides of plate-like portion 12 in direction D3. Alternatively, inserted-to-rotating member portion 13 is provided on each of both sides, interposing the middle portion of adapter 10 in direction D3.

Inserted-to-rotating member portion 13 has projecting portion 14 that protrudes outward from an outer peripheral surface 13b of inserted-to-rotating member portion 13 in the radial direction of inserted-to-rotating member portion 13. Projecting portion 14 is a portion that is to be inserted into a slit 21 of rotating member 20 to be described later. Projecting portion 14 has a cylindrical shape, as an example. Inserted-to-rotating member portion 13 has, for example, recessed portion 15 that is depressed inward in the radial direction from outer peripheral surface 13b of inserted-to-rotating member portion 13. Inserted-to-rotating member portion 13 has a plurality of recessed portions 15, and the plurality of recessed portions 15 are arranged in direction D3. Further, the plurality of recessed portions 15 are arranged in a circumferential direction of inserted-to-rotating member portion 13 (direction in which rotating member 20 rotates with respect to adapter 10). Alternatively, the plurality of recessed portions 15 are arranged in first direction D1.

Inserted-to-rotating member portion 13 has, for example, a protruding portion 16 that protrudes outward in the radial direction of inserted-to-rotating member portion 13. Protruding portion 16 extends from an end portion in direction D3 of inserted-to-rotating member portion 13 toward plate-like portion 12. Inserted-to-rotating member portion 13 has a pair of protruding portions 16 arranged in the radial direction of inserted-to-rotating member portion 13. For example, adapter 10 has a pair of latches 11 arranged in the radial direction of inserted-to-rotating member portion 13, and each latch 11 is formed in the inner side of each protruding portion 16. An outer surface 11b of latch 11 facing outward in the radial direction of inserted-to-rotating member portion 13 is separated from an inner surface 16b of protruding portion 16. This can ensure a length of latch 11 in direction D3, and thus can increase the elastic force of latch 11.

Latch 11 has an elongated shape extending in direction D3. Latch 11 extends in direction D3 in the inner side of protruding portion 16. For example, latch 11 has an arm portion 11c extending in direction D3 and a projecting portion 11d with which optical connector 2 engages. Projecting portion 11d protrudes inward in the radial direction of inserted-to-rotating member portion 13 at the end portion in direction D3 of arm portion 11c.

As shown in FIG. 1, for example, a cross-sectional shape of projecting portion 11d cut along a plane extending in both first direction D1 and direction D3 is a trapezoidal shape. Projecting portion 11d is engaged with recessed portion 5k of front housing 5. As described above, the cross-sectional shape of recessed portion 5k cut along the plane extending in both first direction D1 and direction D3 is a trapezoidal shape. For example, a length of recessed portion 5k in direction D3 is longer than a length of projecting portion 11d in direction D3. Thus, even in a state in which projecting portion 11d is engaged with recessed portion 5k, front housing 5 can be slightly pushed in direction D3 with respect to latch 11.

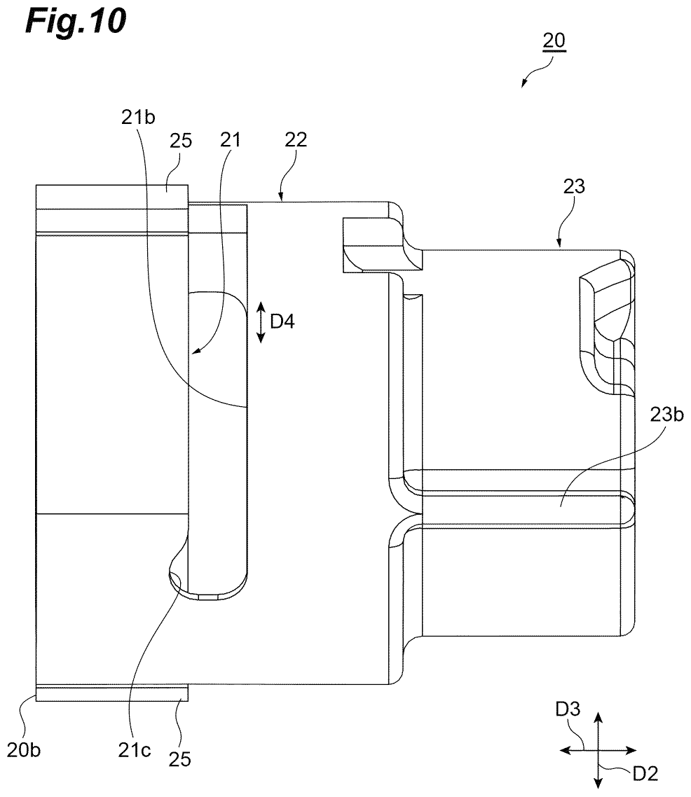

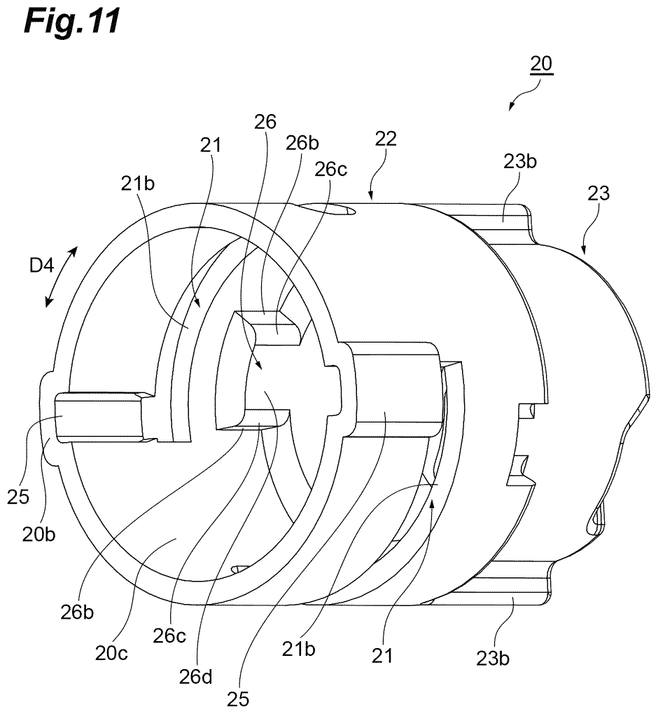

Next, rotating member 20 will be described with reference to FIG. 2, FIG. 10 and FIG. 11. FIG. 10 is a side surface view showing rotating member 20. FIG. 11 is a perspective view showing rotating member 20. Rotating member 20 has, for example, a circular tubular shape. Rotating member 20 has an adapter housing portion 22 having a tubular shape and located closer to the center of optical connection component 1 in direction D3 and a rotation operation portion 23 having a tubular shape and located closer to the end portion of optical connection component 1 in direction D3. Adapter housing portion 22 is a portion for housing adapter 10. For example, an outer diameter of adapter housing portion 22 is larger than an outer diameter of rotation operation portion 23.

Rotating member 20 is provided with an insertion hole 24 into which optical connector 2 is inserted in direction D3, and optical connector 2 inserted into insertion hole 24 is connected to adapter 10. Insertion hole 24 has, for example, a flat shape extending in first direction D1. Adapter housing portion 22 has slit 21 extending in rotation direction D4 (circumferential direction of rotating member 20) which is a direction in which rotating member 20 rotates with respect to adapter 10. For example, rotating member 20 has two slits 21, and two slits 21 are arranged in the radial direction of rotating member 20.

Slit 21 penetrates rotating member 20 in the radial direction of rotating member 20. A length of slit 21 in rotation direction D4 is, for example, equal to or more than 1/12 of a length of rotating member 20 (adapter housing portion 22) in rotation direction D4 and equal to or less than 17/36 of the length of rotating member 20 in rotation direction D4. In this case, a rotation angle of rotating member 20 with respect to adapter 10 is 30 degrees to 170 degrees. Projecting portion 14 of adapter 10 described above is inserted into slit 21 from the inner side of rotating member 20. Thus, rotating member 20 is configured to be rotatable with respect to adapter 10 by the length of slit 21 in rotation direction D4.

Slit 21 has an extending portion 21b extending in rotation direction D4 and a depression 21c recessed in direction D3 at an end portion in rotation direction D4 of extending portion 21b. Depression 21c is depressed toward the front side (toward the center of optical connection component 1 in direction D3) at one end of extending portion 21b in rotation direction D4. Depression 21c is a portion into which projecting portion 14 of adapter 10 enters when optical connector 2 engages with latch 11. Rotating member 20 has a protruding portion 25 protruding outward in the radial direction of rotating member 20 at an end portion of slit 21 opposite to depression 21c. Protruding portion 25 extends from slit 21 to an end surface 20b of rotating member 20 facing direction D3.

Rotation operation portion 23 is, for example, a portion where the rotating operation of rotating member 20 is performed by fingers of a person. Rotation operation portion 23 has a projecting portion 23b which protrudes outward in the radial direction of rotating member 20, and projecting portion 23b extends in direction D3. When projecting portion 23b is formed, rotation operation portion 23 can be easily rotated by being pinched by fingers. For example, rotation operation portion 23 has a plurality of (as an example, two) projecting portions 23b, and the plurality of projecting portions 23b are arranged in the radial direction of rotating member 20.

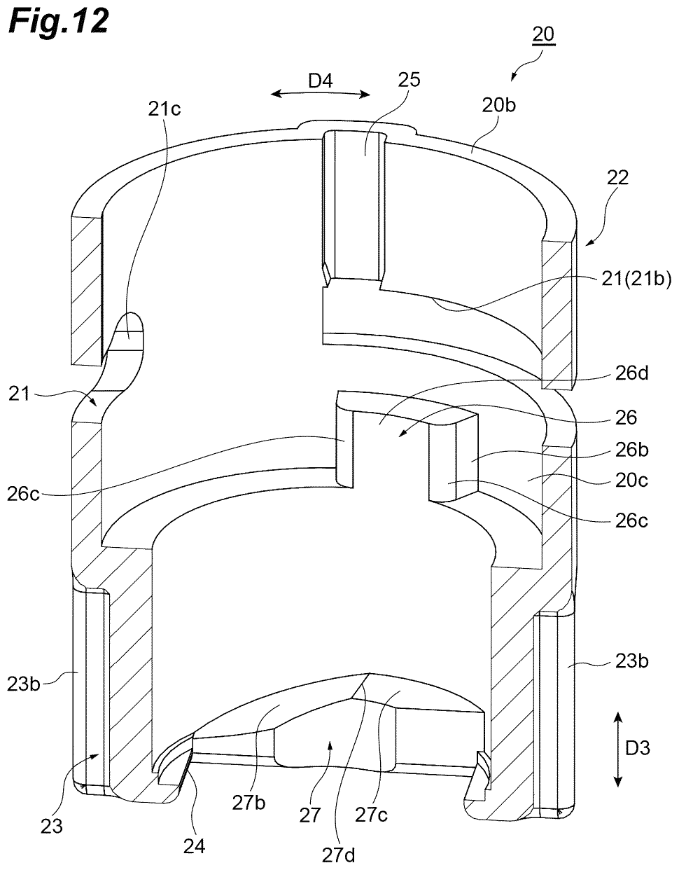

FIG. 12 is a cross-sectional perspective view of rotating member 20. As shown in FIG. 11 and FIG. 12, rotating member 20 has a latch pressing member 26 which protrudes inward in the radial direction of rotating member 20 on an inner peripheral surface 20c of rotating member 20. Latch pressing member 26 is a portion that presses latch 11 of adapter 10 with optical connector 2 engaged from the outer side of latch 11. For example, rotating member 20 has two latch pressing members 26 arranged in the radial direction of rotating member 20. The shape of latch pressing member 26 when viewed in direction D3 is, for example, a trapezoidal shape. As an example, latch pressing member 26 has a pair of inclined surfaces 26b extending inwardly in the radial direction of rotating member 20 from inner peripheral surface 20c of rotating member 20 so as to approach each other, a pair of curved surfaces 26c curved in rotation direction D4 at the inner end portions in the radial direction of respective inclined surfaces 26b, and a top surface 26d extending in rotation direction D4 between the pair of curved surfaces 26c.

Rotating member 20 has a transfer mechanism 27 that transfers optical connector 2 in direction D3 by being rotated in rotation direction D4 with respect to adapter 10 about central axis L (refer to FIG. 1). Rotating member 20 has, for example, a plurality of latch pressing members 26 disposed at positions with insertion hole 24 interposed, and a plurality of transfer mechanisms 27 disposed at positions with insertion hole 24 interposed. In FIG. 12, only latch pressing member 26 on one side and transfer mechanism 27 on one side are shown. For example, transfer mechanism 27 and latch pressing member 26 are disposed so as to be arranged in direction D3. Transfer mechanism 27 is formed between latch pressing member 26 and insertion hole 24. Transfer mechanism 27 has, for example, an inclined surface 27b that comes into contact with optical connector 2 inserted into insertion hole 24 and a top surface 27c to which optical connector 2 being in contact with inclined surface 27b faces.

One end (left end portion in FIG. 12) of inclined surface 27b in rotation direction D4 is close to insertion hole 24. Inclined surface 27b is inclined so as to protrude toward the center of rotating member 20 in direction D3 as inclined surface 27b is separated from the one end of rotating member 20 in rotation direction D4. Top surface 27c extends in rotation direction D4 from the other end of inclined surface 27b in rotation direction D4. For example, latch pressing member 26 and a boundary line 27d of inclined surface 27b and top surface 27c are arranged along direction D3.

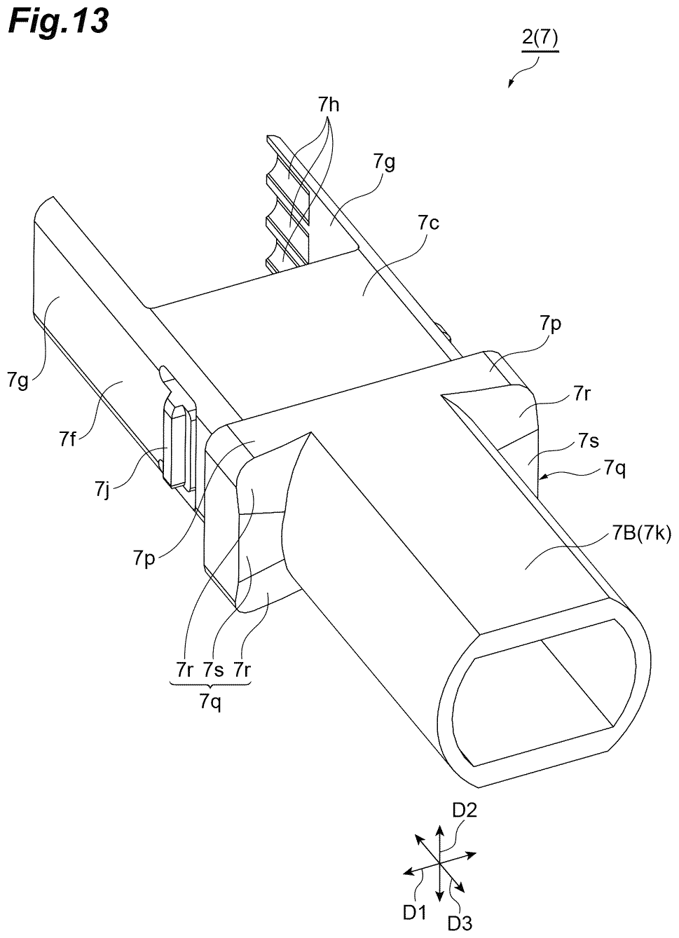

As shown in FIG. 12 and FIG. 13, protruding portion 7p of rear housing 7 of optical connector 2 inserted into the inner side of rotating member 20 through insertion hole 24 comes in contact with inclined surface 27b. Rotating member 20 pushes optical connector 2 being in contact with inclined surface 27b toward adapter 10 (upward in FIG. 12) by rotating. For example, transfer mechanism 27 transfers optical connector 2 toward adapter 10 by bringing inclined surface 27b into surface contact with protruding portion 7p that has entered in the inner side of rotating member 20 from insertion hole 24. More specifically, when rotating member 20 rotates in a state in which protruding portion 7p is inserted into rotating member 20, inclined surface 27b of transfer mechanism 27 comes into surface contact with inclined surface 7r of protruding portion 7p. When rotating member 20 further rotates, inclined surface 27b pushes inclined surface 7r toward the center of rotating member 20 in direction D3, so that protruding portion 7p transfers toward the center of rotating member 20 in direction D3, and optical connector 2 transfers toward adapter 10. As described above, inclined surface 7r and inclined surface 27b correspond to screwing surfaces that comes into contact with each other when rotating member 20 rotates and optical connector 2 is screwed into toward the center of rotating member 20 in direction D3.

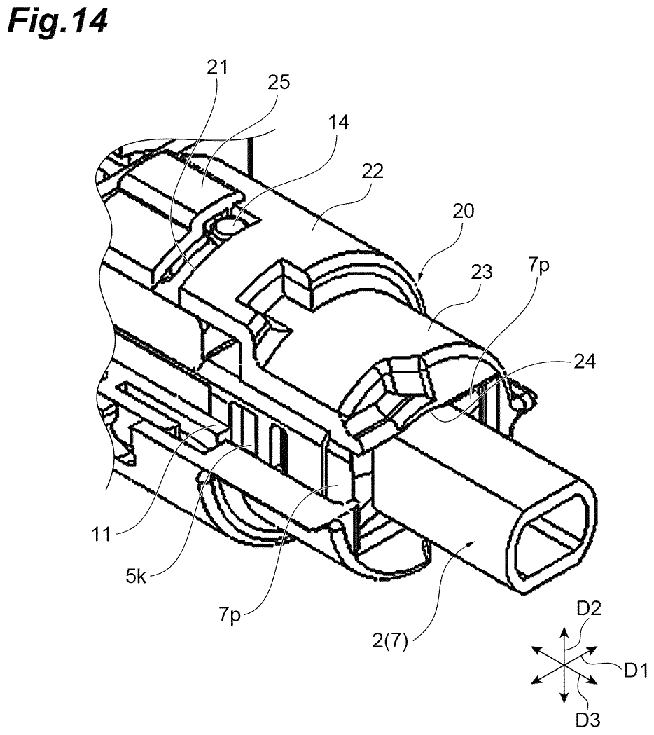

Next, examples of steps of the optical connection method according to the embodiment will be described. First, as shown in FIG. 2, optical connector 2 is disposed so that ferrule 3 faces rotating member 20 attached to adapter 10 (step of disposing the optical connector). Next, as shown in FIG. 14, protruding portion 7p of optical connector 2 is inserted into insertion hole 24 of rotating member 20 (step of inserting the protruding portion).

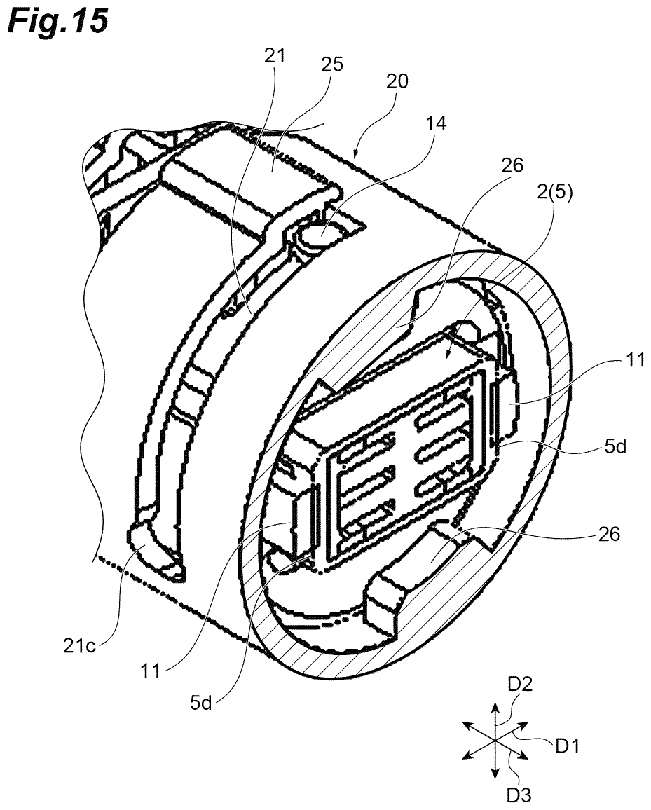

FIG. 15 is a cross-sectional view of optical connector 2, adapter 10, and rotating member 20 in a state in which protruding portion 7p is inserted into insertion hole 24. As shown in FIG. 14 and FIG. 15, immediately after protruding portion 7p is inserted into insertion hole 24, latches 11 of adapter 10 are located on both sides of side surface portion 5d in first direction D1 of front housing 5. Further, projecting portion 14 of adapter 10 is located at an end portion of slit 21 closer to protruding portion 25.

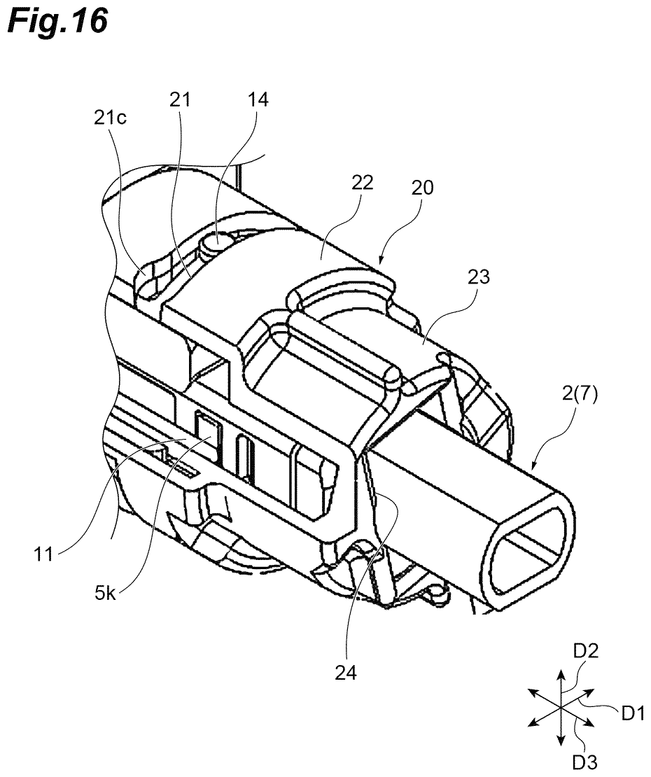

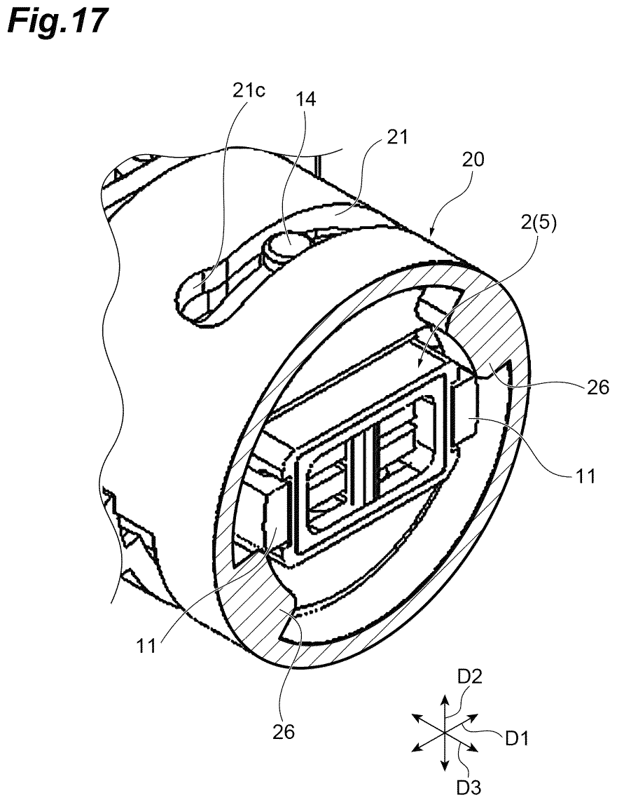

In the above state, when rotating member 20 is rotated with respect to adapter 10, as shown in FIG. 16 and FIG. 17, projecting portion 14 transfers along slit 21 and latch pressing member 26 approaches latch 11. FIG. 16 and FIG. 17 show rotating member 20 rotated by 77 degrees from the state shown in FIG. 14 and FIG. 15. At this time, inclined surface 27b of transfer mechanism 27 described above comes into contact with inclined surface 7r of protruding portion 7p, so that optical connector 2 transfers toward the center in direction D3 (in the upper left direction in each of FIG. 16 and FIG. 17), and recessed portion 5k of front housing 5 approaches latch 11 (step of transferring the optical connector in the optical axis direction). In this state, optical connector 2 is configured to be movable by a predetermined distance (as an example, 0.2 mm) in direction D3.

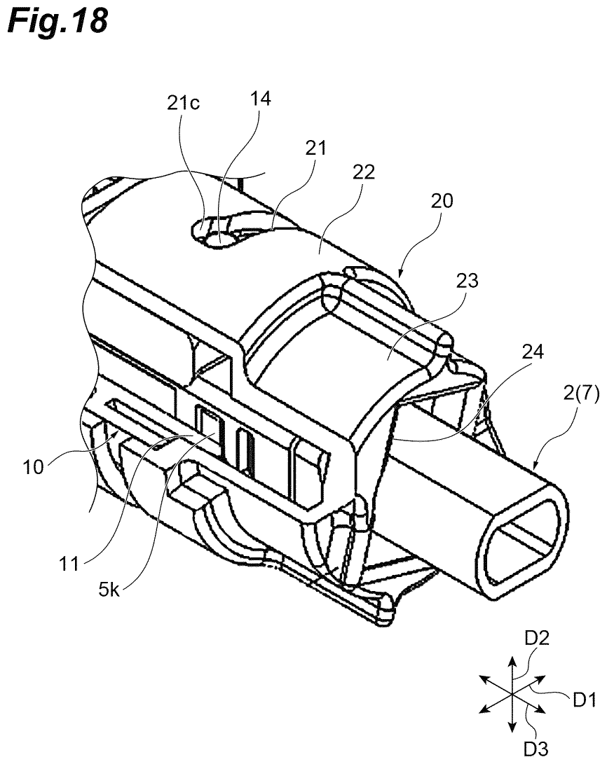

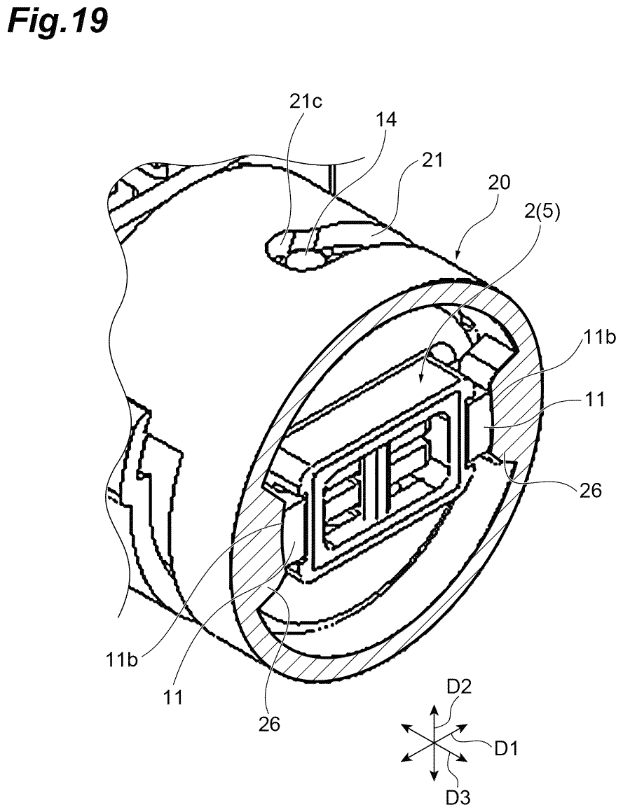

When rotating member 20 is further rotated, projecting portion 14 is transferred to depression 21c of slit 21 as shown in FIG. 18 and FIG. 19. FIG. 18 and FIG. 19 show rotating member 20 rotated by 106 degrees from the state shown in FIG. 14 and FIG. 15. When projecting portion 14 enters depression 21c, rotating member 20 transfers backward (in the lower right direction in each of FIG. 18 and FIG. 19) so that transfer mechanism 27 is separated from optical connector 2 (step of transferring the rotating member backward). At this time, latch pressing member 26 enters latch 11 outward in the radial direction and fastens outer surface 11b of latch 11 inward in the radial direction (step of pressing the latch).

Further, in the above state, as shown in FIG. 1 and FIG. 18, latch 11 of adapter 10 is engaged with recessed portion 5k of optical connector 2 (step of engaging the optical connector). Through the above steps, the connection of optical connector 2 to adapter 10 is completed. It is noted that, mating connector 2A may be connected to adapter 10 through the similar steps as described above. At this time, each guiding pin is inserted into each guiding hole 3c, and the optical connection of optical connector 2 to mating connector 2A is realized. For example, optical fiber F held in ferrule 3 of optical connector 2 is PC-connected to the optical fiber held in ferrule 3 of mating connector 2A. Then, the positional relationship between recessed portion 5k of optical connector 2 and latch 11 of adapter 10 is determined by the spring-back operation of spring member 8 of optical connector 2.

Next, function and effect obtained from optical connection component 1 and the optical connection method according to the embodiment will be described. In optical connection component 1 and the optical connection method according to the embodiment, optical connector 2 has ferrule 3 holding optical fiber F, and optical connector 2 is connected to adapter 10. Adapter 10 has rotating member 20 having transfer mechanism 27 configured to transfer optical connector 2 in direction D3, which is the optical axis direction. Since adapter 10, instead of optical connector 2, has rotating member 20, optical connector 2 can be miniaturized and can be easily inserted into adapter 10 with reduced insertion resistance of connector 2 into adapter 10. Optical connection component 1 includes rotating member 20 that rotates about central axis L extending in direction D3, and rotating member 20 is provided with insertion hole 24 into which optical connector 2 is inserted. Rotating member 20 transfers optical connector 2 in direction D3 by rotating. Thus, optical connector 2 can be transferred in direction D3 by the rotation of rotating member 20, and optical connector 2 can be engaged with latch 11. Thus, optical connector 2 can be easily connected. As a result, an operation force required for the operation of connecting optical connector 2 to adapter 10 can be reduced.

Rotating member 20 may have latch pressing member 26 configured to press latch 11 with optical connector 2 engaged. In this case, latch pressing member 26 presses latch 11 with optical connector 2 engaged, and thus the opening of latch 11 can be more reliably suppressed. Thus, optical connector 2 can be firmly engaged with adapter 10.

Transfer mechanism 27 may have inclined surface 27b that comes into contact with optical connector 2 inserted into insertion hole 24. Rotating member 20 may push optical connector 2 that comes into contact with inclined surface 27b toward adapter 10 by rotating. In this case, since transfer mechanism 27 has inclined surface 27b, the configuration of transfer mechanism 27 for transferring optical connector 2 can be simplified. Optical connector 2 can be pushed toward adapter 10 by rotating member 20 rotating in a state in which optical connector 2 is in contact with inclined surface 27b. Thus, rotating member 20 is rotated, and optical connector 2 can be pushed toward adapter 10, and thus optical connector 2 can be easily connected to adapter 10.

Optical connector 2 may include the plurality of ferrules 3 and housing unit 4 housing the plurality of ferrules 3. In this case, housing unit 4 houses the plurality of ferrules 3, and thus the plurality of ferrules 3 of optical connector 2 can be collectively optically connected.

In housing unit 4, the plurality of ferrules 3 may be arranged in first direction D1, and may be arranged in second direction D2. In this case, the plurality of ferrules 3 arranged in first direction D1 and second direction D2 can be collectively optically connected.

Housing unit 4 may include front housing 5 having recessed portion 5k with which latch 11 engages. In this case, latch 11 of adapter 10 can be engaged with recessed portion 5k formed in front housing 5 of optical connector 2. Front housing 5 may have a rectangular parallelepiped shape. In this case, front housing 5 can be formed in a simple shape, which contributes to further miniaturization of optical connector 2. Ferrule 3 may be housed in front housing 5.

Housing unit 4 may include middle housing 6 including space forming portion 6b forming a space through which optical fiber F held by ferrule 3 passes. In this case, optical fiber F extending from ferrule 3 can be passed through the space of middle housing 6. Optical connector 2 may include spring member 8 interposed between ferrule 3 and middle housing 6. In this case, ferrule 3 can be biased by spring member 8.

Housing unit 4 may include rear housing 7 with which transfer mechanism 27 comes into contact, and middle housing 6 may be housed in rear housing 7. In this case, transfer mechanism 27 can be brought into contact with rear housing 7 that houses middle housing 6.

Rear housing 7 may have tubular portion 7k into which optical fiber F is inserted, and protruding portion 7p protruding from tubular portion 7k in first direction D1. Protruding portion 7p may enter insertion hole 24, and transfer mechanism 27 may transfer optical connector 2 by coming into contact with protruding portion 7p having entered insertion hole 24. In this case, transfer mechanism 27 can transfer optical connector 2 toward adapter 10 by coming into contact with protruding portion 7p that protrudes from tubular portion 7k in first direction D1.

Rear housing 7 may have a non-circular shape in a cross section orthogonal to direction D3. In this case, rear housing 7 can be more easily inserted into insertion hole 24. Rear housing 7 and insertion hole 24 may have flat shapes extending in first direction D1 in a cross section orthogonal to direction D3. In this case, rear housing 7 can be more easily inserted into insertion hole 24.

Rotating member 20 may have the plurality of transfer mechanisms 27 disposed at positions with insertion hole 24 interposed. In this case, when the plurality of transfer mechanisms 27 transfer optical connector 2, optical connector 2 can be more easily connected to adapter 10. Transfer mechanism 27 and latch pressing member 26 may be disposed so as to be arranged in direction D3.

Rotating member 20 may have the plurality of latch pressing members 26 disposed at positions with insertion hole 24 interposed. In this case, since the opening of latch 11 can be suppressed by the plurality of latch pressing members 26, optical connector 2 can be engaged with adapter 10 more firmly.

Rotating member 20 may have adapter housing portion 22 having a tubular shape and configured to house adapter 10. In this case, rotating member 20 can be rotated with respect to adapter 10 in a state in which adapter 10 is housed. Adapter housing portion 22 may have slit 21 extending in rotation direction D4 of rotating member 20. Adapter 10 may have projecting portion 14 that is inserted into slit 21. In this case, rotating member 20 is able to rotate smoothly in rotation direction D4 by rotating rotating member 20 with respect to adapter 10 in a state in which projecting portion 14 is inserted into slit 21.

Slit 21 may have extending portion 21b extending in rotation direction D4, and depression 21c recessed in direction D3 at an end portion in rotation direction D4 of extending portion 21b. Projecting portion 14 may enter depression 21c when optical connector 2 engages with latch 11. Rotating member 20 may transfer in direction D3 so that transfer mechanism 27 separates from optical connector 2 when projecting portion 14 enters depression 21c. In this case, when optical connector 2 engages with latch 11, transfer mechanism 27 of rotating member 20 can be transferred away from optical connector 2.

The rotation angle of rotating member 20 with respect to adapter 10 may be 30 degrees to 170 degrees. As an example, the rotation angle is 106 degrees. In this case, the movement amount of optical connector 2 which transfers as a result of rotation of rotating member 20 can be sufficiently secured.

The embodiment of the optical connection component and the optical connection method according to the present disclosure have been described above. However, the optical connection component and the optical connection method according to the present disclosure are not limited to the above-described embodiment, and can be appropriately modified within the scope of the gist described in the claims. For example, in the above-described embodiment, rotating member 20 including transfer mechanism 27 having inclined surface 27b which is in surface contact with protruding portion 7p of optical connector 2 has been described. However, the configuration of the transfer mechanism is not limited to the above example and can be appropriately changed. For example, it may be a rotating member with a transfer mechanism having a portion that makes point contact with the optical connector.

### REFERENCE SIGNS LIST

1 optical connection component
2 optical connector
2A mating connector
3 ferrule
3b end surface
3c guiding hole
3d optical fiber holding hole
4 housing unit
5 front housing
5b upper surface portion
5c lower surface portion
5d side surface portion
5f first opening
5g second opening
5k recessed portion
5p engagement hole
6 middle housing
6b space forming portion
6c spring disposition portion
6d plate-like portion
6f protruding portion
7 rear housing
7A inserted portion
7b inner side surface
7B exposed portion
7c upper surface portion
7d lower surface portion
7f side surface portion
7g protruding portion
7h spring housing portion
7j projecting portion
7k tubular portion
7p protruding portion
7q surface
7r inclined surface
7s top surface
8 spring member
9 pin keeper
10 adapter
11 latch
11b outer surface
11c arm portion
11d projecting portion
12 plate-like portion
13 inserted-to-rotating member portion
13b outer peripheral surface
14 projecting portion
15 recessed portion
16 protruding portion
16b inner surface
20 rotating member
20b end surface
20c inner peripheral surface
21 slit
21b extending portion
21c depression
22 adapter housing portion
23 rotation operation portion
23b projecting portion
24 insertion hole
25 protruding portion
26 latch pressing member
26b inclined surface
26c curved surface
26d top surface
27 transfer mechanism
27b inclined surface
27c top surface
27d boundary line
D1 first direction
D2 second direction
D3 direction
D4 rotation direction
F optical fiber
L central axis

1. An optical connection component comprising:
an optical connector including a ferrule holding an optical fiber;
a rotating member having an insertion hole into which the optical connector is inserted in an optical axis direction of the optical fiber; and
an adapter to which the optical connector inserted into the insertion hole is connected,
wherein the adapter has a latch with which the optical connector transferring in the optical axis direction engages, and
wherein the rotating member has a transfer mechanism configured to transfer the optical connector in the optical axis direction by rotating with respect to the adapter about a central axis extending in the optical axis direction.

2. The optical connection component according to claim 1, wherein the rotating member has a latch pressing member configured to press the latch with the optical connector engaged.

3. The optical connection component according to claim 1,
wherein the transfer mechanism has an inclined surface that comes into contact with the optical connector inserted into the insertion hole, and
wherein the rotating member pushes the optical connector being in contact with the inclined surface toward the adapter by rotating.

4. The optical connection component according to claim 1, wherein the optical connector includes a plurality of the ferrules and a housing unit housing the plurality of ferrules.

5. The optical connection component according to claim 4, wherein, in the housing unit, the plurality of ferrules are arranged in a first direction intersecting the optical axis direction, and are arranged in a second direction intersecting both the optical axis direction and the first direction.

6. The optical connection component according to claim 4, wherein the housing unit includes a front housing having a recessed portion with which the latch engages.

7. The optical connection component according to claim 6, wherein the front housing has a rectangular parallelepiped shape.

8. The optical connection component according to claim 6, wherein the ferrule is housed in the front housing.

9. The optical connection component according to claim 4, wherein the housing unit includes a middle housing including a space forming portion forming a space through which the optical fiber held by the ferrule passes.

10. The optical connection component according to claim 9, wherein the optical connector includes a spring member interposed between the ferrule and the middle housing.

11. The optical connection component according to claim 9,
wherein the housing unit includes a rear housing with which the transfer mechanism comes into contact, and
wherein the middle housing is housed in the rear housing.

12. The optical connection component according to claim 11,
wherein the rear housing has a tubular portion into which the optical fiber is inserted, and a protruding portion protruding from the tubular portion in a first direction intersecting the optical axis direction,
wherein the protruding portion enters the insertion hole, and
wherein the transfer mechanism transfers the optical connector by coming into contact with the protruding portion having entered the insertion hole.

13. The optical connection component according to claim 11, wherein the rear housing has a non-circular shape in a cross section orthogonal to the optical axis direction.

14. The optical connection component according to claim 11, wherein the rear housing and the insertion hole have flat shapes extending in a first direction intersecting the optical axis direction in a cross section orthogonal to the optical axis direction.

15. The optical connection component according to claim 1, wherein the rotating member has a plurality of the transfer mechanisms disposed at positions with the insertion hole interposed.

16. The optical connection component according to claim 2, wherein the transfer mechanism and the latch pressing member are disposed so as to be arranged in the optical axis direction.

17. The optical connection component according to claim 2, wherein the rotating member has a plurality of the latch pressing members disposed at positions with the insertion hole interposed.

18. The optical connection component according to claim 1, wherein the rotating member has an adapter housing portion having a tubular shape and configured to house the adapter.

19. The optical connection component according to claim 18,
wherein the adapter housing portion has a slit extending in a rotation direction of the rotating member, and
wherein the adapter has a projecting portion that is inserted into the slit.

20. The optical connection component according to claim 19,
wherein the slit has an extending portion extending in the rotation direction, and a depression recessed in the optical axis direction at an end portion in the rotation direction of the extending portion,
wherein the projecting portion enters the depression when the optical connector engages with the latch, and
wherein the rotating member transfers in the optical axis direction so that the transfer mechanism separates from the optical connector when the projecting portion enters the depression.

21. The optical connection component according to claim 1, wherein a rotation angle of the rotating member with respect to the adapter is 30 degrees to 170 degrees.

22. An optical connection method of optically connecting an optical connector including an optical fiber to a mating connector via an adapter, the method comprising:
preparing a rotating member having an insertion hole into which the optical connector is inserted in an optical axis direction of the optical fiber;
inserting the optical connector into the insertion hole; and
by rotating the rotating member with respect to the adapter about a central axis extending in the optical axis direction, transferring the optical connector in the optical axis direction and engaging the optical connector with a latch of the adapter.
